(19) United States
(12) Patent Application Publication
(10) Pub. No.: US 2026/0226274 A1
(43) Pub. Date: Aug. 6, 2026

(54) RECYCLED-AEROGEL COMPOSITE FOR CONSTRUCTION MATERIALS (RAC)

(71) Applicant: Arizona Board of Regents on behalf of Arizona State University, Scottsdale, AZ (US)

(72) Inventors: Carlos Javier Obando Gamboa, Tempe, AZ (US); Kamil Elias Kaloush, Scottsdale, AZ (US); Jolina Karam, Phoenix, AZ (US); Jose Roberto Medina Campillo, Chandler, AZ (US)

(21) Appl. No.: 19/154,830

(22) PCT Filed: Feb. 15, 2024
(86) PCT No.: PCT/US2024/016051

§ 371 Date: Aug. 8, 2025

Related U.S. Application Data
(60) Provisional application No. 63/485,183, filed on Feb. 15, 2023.

(51) Int. Cl. C08L 95/00

(52) U.S. Cl. CPC C08L 95/00; C08L 2555/34

(57) ABSTRACT

A recycled-aerogel composite includes a multiplicity of swelled crumb rubber particles and a filler. Each swelled crumb rubber particle includes a crumb rubber particle defining pores, and oil distributed throughout the pores. The filler includes a multiplicity of fibers, aerogel material, or both. A modified asphalt binder includes asphalt binder and the recycled-aerogel composite. An asphalt pavement includes the modified asphalt binder and aggregate. Methods of making the modified asphalt binder and a recycled-aerogel composite are described.

### CROSS-REFERENCE TO RELATED APPLICATION

This application claims the benefit of U.S. Patent Application No. 63/485,183 filed on Feb. 15, 2023, which is incorporated by reference herein in its entirety.

### TECHNICAL FIELD

This invention relates to a recycled-aerogel composite (RaC) including recycled materials such as crumb rubber particles, oil, and a filler including fibers, an aerogel material, or both, and in some cases an encapsulator, as well as methods of making the recycled-aerogel composite.

### BACKGROUND

Construction materials like hot mix asphalt (HMA) pavements and Portland Cement Concrete mixtures include aggregate materials and a binder, e.g., asphalt binder or Portland cement to help to hold the aggregate materials together. Both materials are typically thermally susceptible. Expansion-contraction of the materials due to temperature fluctuation can negatively contribute to their performance.

### SUMMARY

This disclosure relates to a recycled-aerogel composite (RaC) including recycled materials such as crumb rubber particles, oil, and a filler including fibers, and aerogel material, or both, and in some cases an encapsulator, as well as methods of making the recycled-aerogel composite. The aerogel material can be in the form of particles, fibers, or strips. The recycled-aerogel composite is combined with asphalt binder or asphalt mixtures to yield modified material with improved characteristics. Crumb rubber particles can be pre-soaked in oil to yield swelled rubber crumb particles. The swelled crumb rubber particles improve the flexibility and strength of the modified asphalt binder. Adding aerogel material in form of particles, fibers, or strips enhances thermal resistance of the modified material and renders it less susceptible to thermal cycling and fatigue. The swelled crumb rubber particles and the aerogel material can be combined with an encapsulator. The encapsulator coats the swelled crumb rubber particles and the aerogel material. The coating can facilitate better distribution of the swelled crumb rubber particles and the aerogel material when the composite is added to asphalt binder or mixture. The weight added to the aerogel material by the encapsulator coating can reduce the aerosol suspension of the aerogel material. However, aerogel in form of particles, fibers, or strips can be also treated with an encapsulator separately prior to blending with the swelled crumb rubber. Recycled aerogel in the form of particles, fibers, or strips can be also added, treated or not treated with an encapsulator, to the swelled crumb rubber or directly to the construction material (e.g., asphalt binders or mixtures).

Although the disclosed inventive concepts include those defined in the attached claims, it should be understood that the inventive concepts can also be defined in accordance with the following embodiments.

Embodiment 1 is a recycled-aerogel composite comprising:
a multiplicity of swelled crumb rubber particles, wherein each swelled crumb rubber particle comprises:
   a crumb rubber particle defining pores; and
   oil distributed throughout the pores; and
a filler comprising:
   a multiplicity of fibers;
   aerogel material; or
   both.

Embodiment 2 is recycled-aerogel composite of embodiment 1, wherein the multiplicity of fibers comprises synthetic fibers or fibers of vegetable or animal origin.

Embodiment 3 is the recycled-aerogel composite of embodiment 1 or 2, wherein each fiber in the multiplicity of fibers has a diameter in a range of about 5 microns to about 20 microns and a length in a range of about 1 centimeter to about 10 centimeters.

Embodiment 4 is the recycled-aerogel composite of any one of embodiments 1-3, wherein the aerogel material comprises a crosslinked aerogel.

Embodiment 5 is the recycled-aerogel composite of embodiment 4, wherein the crosslinked aerogel comprises silica aerogel crosslinked with polystyrene.

Embodiment 6 is the recycled-aerogel composite of any one of embodiments 1-5, wherein the aerogel material comprises aerogel-based virgin or recycled material.

Embodiment 7 is the recycled-aerogel composite of any one of embodiments 1-6, the aerogel material comprises aerogel particles, aerogel fibers, or aerogel strips.

Embodiment 8 is the recycled-aerogel composite of embodiment 7, wherein the aerogel particles have a diameter in a range of about 50 microns to about 100 microns.

Embodiment 9 is the recycled-aerogel composite of any one of embodiments 1-8, wherein the aerogel particles have a diameter in a range between about 500 microns and about 3 millimeters.

Embodiment 10 is the recycled-aerogel composite of embodiment 7, wherein the aerogel fibers have a diameter in a range between about 5 microns and about 40 microns and a length between about 1 centimeter and about 10 centimeters.

Embodiment 11 is the recycled-aerogel composite of embodiment 7, wherein the aerogel strips have a width in a range between about 5 microns and about 40 microns and a length between about 1 centimeter and about 10 centimeters.

Embodiment 12 is the recycled-aerogel composite of embodiments 1-11, further comprising an encapsulator.

Embodiment 13 is the recycled-aerogel composite of embodiment 12, comprising about 1 wt % to about 10 wt % of the encapsulator.

Embodiment 14 is the recycled-aerogel composite of embodiment 12 or 13, wherein the encapsulator comprises one or more asphalt binders, polymers, bio-binders, heavy oil products bio-derived compounds, bio-oils, or any combination thereof.

Embodiment 15 is the recycled-aerogel composite of embodiment 14, wherein a weight ratio of the aerogel material to the asphalt binder is in a range of about 1:10 to about 3:4.

Embodiment 16 is the recycled-aerogel composite of any one of embodiments 12-15, wherein the encapsulator comprises one or more heavy oil products, synthetic polymers, organic polymers, bio-derived compounds, bio-oils, or any combination thereof.

Embodiment 17 is the recycled-aerogel composite of embodiment 16, wherein the bio-derived compounds comprise lignin, polymers, tree resin, or a combination thereof.

Embodiment 18 is the recycled-aerogel composite of embodiment 17, wherein the polymers comprise poly(ethylene glycol) (PEG), poly(propylene glycol) (PPG), poly(tetrahydrofuran) (PTHF), or a combination thereof.

Embodiment 19 is the recycled-aerogel composite of embodiment 17, wherein the lignin comprises industrial lignin.

Embodiment 20 is the recycled-aerogel composite of any one of embodiments 12-19, wherein the encapsulator at least partially encapsulates each of the swelled crumb rubber particles.

Embodiment 21 is the recycled-aerogel composite of any one of embodiments 12-20, wherein the encapsulator at least partially encapsulates the multiplicity of fibers, the aerogel material, or both.

Embodiment 22 is the recycled-aerogel composite of any one of embodiments 1-21, wherein each crumb rubber particle of the multiplicity of crumb rubber particles has an average diameter in a range of about 0.2 millimeters to about 2 millimeters.

Embodiment 23 is the recycled-aerogel composite of any one of embodiments 1-22, wherein the multiplicity of crumb rubber particles comprise recycled tire rubber.

Embodiment 24 is the recycled-aerogel composite of any one of embodiments 1-23, wherein the oil comprises waste oil.

Embodiment 25 is the recycled-aerogel composite of embodiment 24, wherein the waste oil comprises one or more of waste petroleum-based oil, waste bio-oil, and waste cooking oil.

Embodiment 26 is the recycled-aerogel composite of any one of embodiments 1-25, wherein the swelled crumb rubber particles comprise an oil to crumb rubber particle weight ratio between about 1:4 and about 1:3.

Embodiment 27 is the recycled-aerogel composite of any one of embodiments 1-26, wherein a weight ratio of the swelled crumb rubber particles to the aerogel material is in range of about 1:20 to about 20:1.

Embodiment 28 is a modified asphalt binder comprising:
asphalt binder;
a multiplicity of swelled crumb rubber particles, wherein each swelled crumb rubber particle comprises:
   a crumb rubber particle defining pores; and
   oil distributed throughout the pores; and
a filler comprising:
   a multiplicity of fibers;
   aerogel material; or
   both.

Embodiment 29 is the modified asphalt binder of embodiment 28, wherein the aerogel material comprises aerogel particles, aerogel fibers, or aerogel strips.

Embodiment 30 is the modified asphalt binder of embodiment 28 or 29, wherein a weight ratio of the asphalt binder to the aerogel material (e.g., fibers) is in a range of about 50:1 to about 20:1.

Embodiment 31 is an asphalt pavement comprising:
the modified asphalt binder of any one of embodiments 28-30; and
aggregate.

Embodiment 32 is the asphalt pavement of embodiment 31, wherein the aerogel material comprises aerogel particles, aerogel fibers, or aerogel strips.

Embodiment 33 is the asphalt pavement of embodiment 31 or 32, wherein a weight of ratio of the asphalt binder to the aerogel material (e.g., aerogel fibers) is in a range of about 50:1 to about 20:1.

Embodiment 34 is the asphalt pavement of any of embodiments 31-33, wherein a weight of ratio of the aggregate to the aerogel material is in range of about 350:1 to about 900:1.

Embodiment 35 is a method of making modified asphalt binder, the method comprising combining an asphalt binder with the recycled-aerogel composite of any one of embodiments 1-27 to yield the modified asphalt binder.

Embodiment 36 is the method of embodiment 35, further comprising heating the asphalt binder to a temperature in a range of about 155° C. to about 160° C. before combining the asphalt binder with the recycled-aerogel composite.

Embodiment 37 is the method of embodiment 35 or 36, further comprising heating the asphalt binder to a temperature in a range of about 180° C. to about 200° C. before combining the asphalt binder with the recycled-aerogel composite.

Embodiment 38 is the method of any one of embodiments 35-37, wherein the asphalt binder is at a temperature in a range of about 20° C. to about 30° C.

Embodiment 39 is a method of making a recycled-aerogel composite, the method comprising:
contacting crumb rubber particles with oil to yield swelled crumb rubber particles;
combining the swelled crumb rubber particles with an encapsulator to yield a mixture; and
combining the mixture with aerogel material to yield the recycled-aerogel composite.

Embodiment 40 is a method of making a recycled-aerogel composite, the method comprising:
contacting crumb rubber particles with oil to yield swelled crumb rubber particles;
combining the swelled crumb rubber particles and aerogel material to yield a mixture; and
combining an encapsulator with the mixture, wherein the encapsulator at least partially encapsulates each of the swelled crumb rubber particles and the aerogel material.

Advantages of the modified asphalt binder with RaC include thermal resistance, improved performance, better aging resistance, and enhanced durability relative to the asphalt binder/mixture prior to the addition of the RaC. Better binder durability mitigates distresses and leads to a longer asphalt pavement life span with reduced maintenance activities. The swelled crumb rubber particles absorb little or no oil from the modified asphalt binder. Oil is one of the primary components of bituminous materials. The preservation of this oil by using swelled crumb rubber particles provides flexibility and elasticity to the modified asphalt binder. The RaC provides benefits to the modified asphalt binder including better structural performance and better thermal properties by combining the effects of swelled crumb rubber particles, fibers, and aerogel material. The RaC decreases the thermal susceptibility of the modified asphalt materials and improves the resistance of the modified asphalt mixtures to thermal fatigue. The reduction of the probability of aerosol suspension by encapsulation of the aerogel material provides an increased measure of safety for the use of the modified asphalt binder. The implementation of the RaC can also advance environmentally sustainable technology by utilizing the recycling streams of waste rubber, aerogel-based waste material (e.g., particles, fibers, strips, powder, etc.), and waste oil.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows a plot of temperature dependence of the viscosity susceptibility for control and modified asphalt binders.

FIG. 2 shows dynamic modulus master curves for control and modified asphalt binders.

### DETAILED DESCRIPTION

This disclosure describes recycled-aerogel composites (RaCs) including crumb rubber particles, oil, a filler including fibers (e.g., synthetic fibers or fibers of animal or vegetable origin), aerogel material, or both, and in some cases an encapsulator. Each fiber in the multiplicity of fibers has a diameter in a range of about 5 microns to about 20 microns and a length in a range of about 1 centimeter to about 10 centimeters. The aerogel material can be in the form of particles, fibers, or strips. A modified asphalt binder including aerogel fibers and RaC is described. Methods of making the RaC and the modified asphalt binder are also described.

As used herein, “crumb rubber” particles generally refer to rubber particles from recycled rubber materials, such as scrap automobile and truck tires. The crumb rubber particles typically have a diameter in a range of 0.2 millimeters to 2.0 millimeters. The crumb rubber particles are porous, with pores defined throughout each crumb rubber particle. The oil is absorbed and distributed throughout the pores in each crumb rubber particle. The oil can be originally processed or include waste oil. Examples of waste oils include waste petroleum-based oil, waste bio-oil, waste vegetable oil, waste cooking oil, and the like. Distribution of the oil throughout the pores in each crumb rubber particle yields swelled crumb rubber particles. The swelled crumb rubber particles comprise an oil to crumb rubber particle weight ratio between about 1:4 and about 1:3.

The aerogel material in the modified crumb rubber composite can be in the form of particles, fibers, or strips, and is typically composed of silica. The aerogel material can include cross linked aerogels (e.g., silica aerogels cross-linked with polystyrene). The aerogel material can be in granular or powder form, or in the form of fibers or strips. The aerogel particles have a diameter in a range of about 50 microns to about 3 millimeters (e.g., about 50 microns to about 100 microns, or about 500 microns to about 3 millimeters). The aerogel fibers have a diameter in a range between 5 microns and 40 microns and a length between about 1 centimeter and about 10 centimeters. The aerogel strips have a width in a range between about 5 microns and about 40 microns and a length between about 1 centimeter and about 10 centimeters.

A weight ratio of the swelled crumb rubber particles to the aerogel material is typically in range of about 1:20 to about 20:1. A weight of ratio of the asphalt binder to the aerogel material (e.g., aerogel fibers) is in a range of about 50:1 to about 20:1. The aerogel material decreases the thermal susceptibility of the modified asphalt binder and improves the resistance of the modified asphalt binder to thermal fatigue.

The encapsulator in the RaC can include one or more of a variety of components, such as by-products of a petroleum-refinery system (e.g., a heavy oil product, an asphalt binder), synthetic polymers, organic polymers, bio-derived compounds, and bio-oils. Examples of bio-derived compounds include lignin, industrial lignin, and tree resin. Examples of bio-derived polymers include poly(ethylene glycol) (PEG), poly(propylene glycol) (PPG), poly(tetrahydrofuran) (PTHF), or a combination thereof. The encapsulator at least partially coats the swelled crumb rubber particles and aerogel material individually. The RaC typically includes about 1 wt % to about 10 wt % of the encapsulator.

Methods of making the RaC include contacting the crumb rubber particles with the oil for a length of time (e.g., 24 hours) to yield swelled crumb rubber particles. In some embodiments, the swelled crumb rubber particles are combined with aerogel material to yield a mixture, and the mixture is combined with an encapsulator. Making the RaC can include heating the encapsulator above room temperature before combining the encapsulator with the mixture, while combining the encapsulator with the mixture, or both. In some embodiments, the swelled crumb rubber particles are combined with the encapsulator to yield a mixture, and the mixture is combined with the aerogel material. Making the RaC can include heating the encapsulator above room temperature before combining the encapsulator with the swelled crumb rubber particles, while combining the encapsulator with the swelled crumb rubber particles, or both. The encapsulator at least partially encapsulates each of the swelled crumb rubber particles and each of the aerogel material to form the RaC.

When the encapsulator is an asphalt binder, the encapsulator can be heated to a temperature of about 180° C. to about 200° C. before combining with the mixture or the crumb rubber particles. The swelled crumb rubber particles and asphalt binder can be mixed at a weight ratio in a range of about 1:10 to about 3:4. The RaC can include various weight ratios of aerogel material to asphalt binder. In some embodiments, the aerogel material and the asphalt binder can be combined at a weight ratio in a range of about 1:10 to about 3:4.

The RaC can be combined with an asphalt binder to yield a modified asphalt binder. This asphalt binder can be the same or different as any asphalt binder used as the encapsulator. Examples of suitable asphalt binders include PG58 and PG64. The modified asphalt binder typically includes about 5 wt % to about 25 wt % of the RaC. Making a modified asphalt binder includes heating an asphalt binder to a temperature in a range between about 155° C. and about 160° C., and combining the heated asphalt binder and the RaC to yield a mixture. The mixture can be processed to uniformly distribute the RaC throughout the heated asphalt binder.

In some embodiments, the modified asphalt binder can be combined with aggregates to yield asphalt paving mixtures. A weight of ratio of the aggregate to the aerogel material (e.g., aerogel fibers) is in a range of about 350:1 to about 900:1.

### EXAMPLES

### Recycled-Aerogel Composite (RaC)

The recycled-aerogel composite (RaC) was prepared using swelled crumb rubber particles. Untreated crumb rubber particles were soaked in waste oil for 24 hours. The swelled crumb rubber particles included an oil to crumb rubber particle weight ratio in a range up to 1:4 depending on the final use of the composite. Using the swelled crumb rubber particles, the RaC was made using either a warm method (WM) or a cold method (CM).

The warm method used hot asphalt binder as the encapsulator. In this process, asphalt binder was heated to a temperature in a range between 180° C. and 200° C. The asphalt binder could be any performance grade (PG) but a softer grade is preferable. The asphalt binder served as the encapsulator for this composite. The swelled crumb rubber particles were added to the hot binder and mixed with a high-speed mixer. The rotations per minute (RPM) could range between 200 and 700 with a time duration ranging between 20 and 300 seconds. The weight ratio of the swelled crumb rubber particles to asphalt binder was in a range of about 1:10 to 3:4. The aerogel material was added to the swelled crumb rubber particle-asphalt binder mixture maintained at a temperature between 180° C. and 200° C. The aerogel material had a maximum diameter of 2 mm. The weight ratio of the aerogel material to asphalt binder was in a range of about 1:10 to 3:4. The aerogel material was added gradually to the hot binder and swelled crumb rubber mixture while being stirred between 500 and 800 RPM. The final process took between 1 and 3 minutes. The final product was a dry particulate composite.

The cold method (CM) used to make the RaC does not require heating the encapsulator above room temperature. Suitable encapsulators include co-products of the petroleum-refinery system (e.g., heavy oil products, asphalt emulsions), synthetic polymers, organic polymers, latex, bio-derived compounds, bio-oils, lignin, industrial lignin, and tree resin. In this disclosure, latex was used as the encapsulator for the cold method. The swelled crumb rubber particles were mixed with aerogel material, and the swelled crumb rubber particles and the aerogel material were coated with the encapsulator. The ratio of the main components of the composite can be varied depending on the desired usages. If more flexibility is advantageous, a higher percentage of swelled crumb rubber particles can be used. If high thermal insulative properties are advantageous, a higher percentage of the aerogel material can be used. Thus, the weight ratio of the swelled crumb rubber particles to aerogel material can be in a range of about 1:20 to 20:1. The recycled-aerogel composite included the encapsulator in a range of 1 wt % to 10 wt %. The amount of encapsulator used scaled proportionally with the amount of aerogel material used. The swelled rubber crumb particles, aerogel material, and encapsulator were mixed with a regular mixer (e.g., endless screw mixer) at low speed (e.g., between 20 and 100 RPM). The final product was a dry particulate composite.

### Modified Asphalt Binder

The procedure to make the modified asphalt binder using the recycled-aerogel composite included preheating asphalt binder of performance grade PG70-10 in an oven to 160° C. For softer binders (e.g., PG50 to PG60) it was sufficient to heat the binder to 155° C.

RaC in the amount of 20 wt % was added to the heated binder using a metallic spoon. The binder and composite were thoroughly mixed by means of a wooden stick for 1 minute by hand to ensure dispersion of the particles to yield the modified asphalt binder.

### Tests of Control and Modified Asphalt Binders

Tests were performed to compare the physical characteristics and performance of unmodified control asphalt binders with asphalt binders modified with the disclosed RaC. An asphalt binder with performance grading PG70-10 was used as a control sample. This binder was modified with 20 wt % of the composite relative to the binder weight. The composite used for the modified asphalt binder was made using both the warm method (WM) and the cold method (CM). Results of the tests were also compared with a polymer modified binder (SBS) PG76-22. The SBS binder performance is rated for high temperature (76° C.) and low temperature (−22° C.), and thus served as a good performance benchmark control.

Temperature susceptibility tests of the asphalt binders included the determination of penetration, viscosity, and softening data. Softening point data were obtained with tests based on ASTM D36/D36M-14 (Standard Test Method for Softening Point of Bitumen, Ring-and-Ball Apparatus). The penetration test at 25° C. used was based on ASTM D5-97 (Standard Test Method for Penetration of Bituminous Materials). Rotational viscosity was determined at different temperatures according to ASTM D4402-02 (Standard Test Method for Viscosity Determination of Asphalt at Elevated Temperatures Using a Rotational Viscometer).

Rheology tests of the binders were performed using the Dynamic Shear Rheometer (DSR) as per ASTM D7175-08 (Standard Test Method for Determining the Rheological Properties of Asphalt Binder Using a Dynamic Shear Rheometer). Tests such as High Temperature Performance Grading as per AASHTO M320 and the Stress Creep and Recovery (MSCR) based on AASHTO M-332-14 (Performance-Graded Asphalt Binder Using Multiple Stress Creep Recovery) were done using Dynamic Stress Rheometer (DSR). The pull off tensile strength of asphalt binder from a siliceous surface was measured and determined via the Asphalt Binder Bond Strength (BBS) test according to AASHTO TP 91.

To perform thermal conductivity (TC) tests of asphalt binders, the samples were poured into a cylindrical silicon mold with a height of 25 mm, a half-height indent of 2 mm in the center, and a total radius of 20 mm. After being demolded, thermocouples were placed on the sample to track the temperature change between the sample's inner and outer layers.

Specific heat capacity (Cp) tests included heating the specimens in the oven for 1 hour and then submerging them into water at room temperature. The system was placed in a completely insulated container, minimizing the energy exchange with the exterior environment. To perform the test, asphalt binder samples were poured into a cylindrical silicon mold with a height of 25 mm and a radius of 20 mm.

Flexural creep stiffness of asphalt binders was measured using the bending beam rheometer (BBR) as per AASHTO T 313-19. Based on the results the low temperature performance grading of the binders was determined.

The toughness and tenacity of asphalt materials test was performed as per ASTM D5801. The total work required to separate the material from the tension head as well as post peak behavior, known as tenacity, were determined.

### Test Results—Control and Modified Asphalt Binders

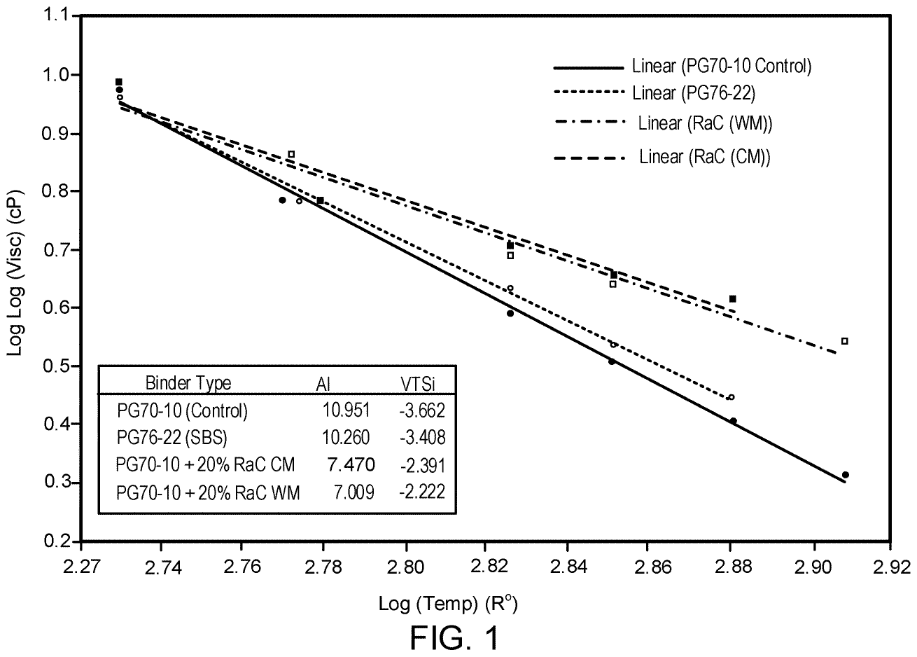

Temperature susceptibility of asphalt binders. Both WM and CM 20% modified asphalt binder showed lower temperature susceptibility slopes with respect to control (PG70-10) and SBS. This indicated that binders modified with the RaC had lower susceptibility to temperature changes. FIG. 1 shows the results for binders PG70-10, PG76-22, and PG70-10 modified with 20% RaC using the WM and the CM. A tabular inset in FIG. 1 provides the viscosity-temperature susceptibility parameters Ai and VTSi. VTSi and Ai parameters represent the slope and the y-intercept respectively. The lower the slope (VTSi) the more stable behavior at different temperatures. The flatter the curves the better thermal response (e.g., less deformation). Additionally, the parameter Ai, which represents the viscosity of the binder at low temperature, is lower for all binders modified with RaC. This aspect indicates that the modified binders have lower viscosity at lower temperatures, which means the modified binders have a lower cracking potential due to stiffening at low temperatures.

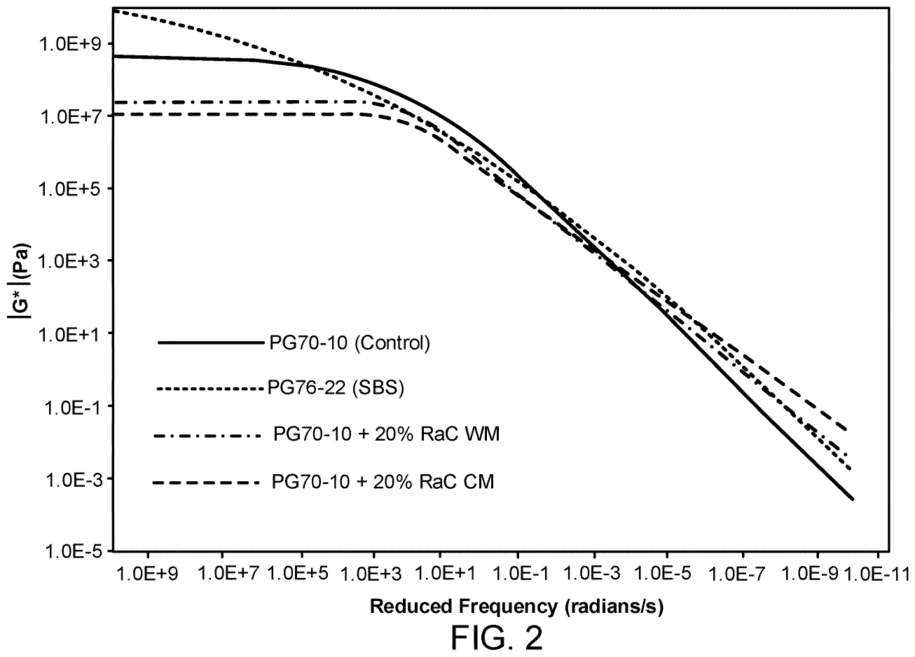

Rheology of the binders using the Dynamic Shear Rheometer (DSR). The most common way to present dynamic shear modulus is the master curve function. The analysis of |G*| for all the binders is presented in FIG. 2. |G*| increases with the addition of the RaC, showing advantageous performance of the binder at high temperatures. At low temperature, |G*| of composite modified asphalt binders decreases, which means a better performance under these conditions. In general, having RaC mixed with binder improves the binder performance at high and low temperatures. This means that asphalt pavement including the modified asphalt binder would exhibit improved resistance to rutting and cracking compared to untreated asphalt pavement.

High temperature performance grading. The classification of an asphalt binder using the asphalt pavement relative performance at different temperatures is defined as the performance grade (PG). This methodology is based on the premise that asphalt binder properties should be related to the conditions under which the binder is used (e.g., air and pavement temperatures). Table 1 presents the PG grading results; note that the gap between the DSR's plates is 2 mm to avoid friction bias readings due to the presence of composite particles.

According to Table 1, high temperature PG grading for unaged binders (at ratio of complex shear modulus G* to sine of the phase angle δ, G/sin(δ)≥1.1 kPa, at an angular frequency of 10 rad/sec) increases when the RaC made using both the WM and CM is included. This means that the presence of the RaC in the asphalt binder significantly improves the performance of the binders at high temperatures. The addition of the composite in binder PG70-10 increased its high temperature performance grading in 30° C. These improvements make the composite-modified binder PG70-10 better performing than an SBS binder PG76-22.

Stress Creep and Recovery (MSCR). The Stress Creep and Recovery (MSCR) test measures the rutting behavior of the pavement structures. It determines the accumulated permanent strain (which is represented by the rutting depth) and the percent of strain recovery under a cyclic load of 0.1 s loading and 0.9 s resting period. This test was performed at the high temperature PG grading of all the binders studied.

Table 1 shows that the recovery values for the specimen having the RaC made using both the WM and the CM are considerably higher than control and very near to the SBS sample. A large portion of the strain is recovered (Rec %), whereas for the control binder the percent recovery is relatively low. The non-recoverable creep compliance (Jnr) decreased with the addition of the composite. This reflects that binders modified with the RaC provide better performance in terms of rutting distresses.

TABLE 1
High Temperature PG grading and Recovery and Jnr results.

| High Temperature | | Jnr | Rec % |
|---|---|---|---|
| PG (° C.) | Sample | (0.1) | (0.1) |
| 70 | PG70-10 (Control) | 7.1 | 0.0 |
| 76 | PG76-22 (SBS) | 5.4 | 20.7 |
| 88 | PG70-10 + 20% RaC WM | 4.2 | 15.5 |
| 100 | PG70-10 + 20% RaC CM | 6.1 | 15.0 |

Asphalt Binder Bond Strength (BBS). The asphalt binder bond strength (BBS) was determined for the different binders. Failure in the pull-off test must be by cohesion (failure in the binder) not by adhesion, where a total separation between binder and substrate is observed. In this context, it is possible to conclude that composite modified asphalt binder samples performed well. The addition of the RaC to the asphalt binders does not negatively affect the bonding mechanisms between the substrate (in this case the aggregates) and the asphalt binder. Table 2 provides the results of this test.

TABLE 2
Binder Bond Strength test results for all the binder types.

| BBS | Average (kPa) | Failure Mode |
|---|---|---|
| PG70-10 (Control) | 401 | Cohesive |
| PG76-22 (SBS) | 417 | Adhesive |
| PG70-10 + 20% RaC WM | 327 | Cohesive |
| PG70-10 + 25% RaC CM | 294 | Cohesive |

Thermal conductivity (TC) and specific heat capacity (Cp) of asphalt binders. Thermal conductivity decreases when the RaC is added to the asphalt binder. Thus, the asphalt binder including RaC is less thermally susceptible than unmodified asphalt binder. It is known that asphalt binders are highly susceptible to temperature changes, particularly at high temperatures. Thus, achieving a lower thermal conductivity would provide insulating properties to the asphalt binder. The lower thermal conductivity improves the thermal response of asphalt pavements. The addition of the RaC to the binder increases Cp. Table 3 presents a summary of thermal conductivity for binders analyzed.

TABLE 3
Thermal Conductivity and Specific Heat Capacity of Binders

| Binder Type | k (W/m° K) | Cp (J/Kg° K) |
|---|---|---|
| PG70-10 (Control) | 0.219 | 941 |
| PG76-22 (SBS) | 0.194 | 1,119 |
| PG70-10 + 20% RaC WM | 0.188 | 989 |
| PG70-10 + 20% aRaC CM | 0.186 | 1,004 |

The presence of RaC decreases the thermal conductivity of the modified asphalt binders, decreasing the heat conduction within the modified asphalt binder. The aerogel is known to have a higher specific heat capacity than asphalt binder. For this reason, adding RaC to asphalt binders increases the Cp of the modified asphalt binder. By having a higher specific heat capacity and lower thermal conductivity, composite modified materials will behave as an insulator, keeping the heat outside the structure and making it less temperature susceptible. The heat penetration will be decreased, and more energy will be required to raise the temperature of the material (higher specific heat capacity). In other words, the asphalt binder modified with the crumb rubber composite may heat up and cool down at lower rate making it less thermal susceptible.

Low temperature performance grading. Low temperature performance grading describes the low temperature stress-strain response of the samples. The m-value is the absolute value of the slope of the logarithm of stiffness vs. time. The higher the m-value the more flexible binder at low temperatures. It is advantageous that the binder is relatively soft at low temperatures and that it can relax (deform) quickly enough to prevent cracking. The results for control and the modified binders are summarized in Table 4. Taking the temperature vs. m-value and temperature vs. stiffness at two different temperatures, it was assumed to be linear behavior to obtain the low PG grading considering the Superpave binder specification requirements. The evaluation of binders at low temperature requires a high m-value because as thermal stresses accumulate and the temperature decreases, the stiffness changes quite fast. A fast change in stiffness means that the binder tends to release stresses that would otherwise reach a level where low temperature cracking would occur. The Superpave binder specification requires a minimum m-value of 0.300. To prevent cracking, creep stiffness had a maximum limit of 300 MPa.

TABLE 4
Low Temperature Performance Grading of Binders

| | Maximum Stiffness | Minimum m-value |
|---|---|---|
| | 300 Mpa | 0.300 |
| Stiffness Evaluation | PG | PG |
| Control PG70-10 | −13.06 | −10.61 |
| PG76-22 (SBS) | −27.73 | −21.32 |
| PG70-10 + 20% RaC WM | −26.16 | −16.10 |
| PG70-10 + 20% RaC CM | −20.12 | −14.94 |

The presence of the RaC in the modified asphalt binder significantly improves the performance of the binders at low temperatures. The addition of the RaC to a binder PG70-10 increased its low temperature performance grading to −26° C. These improvements made the composite-modified binder PG70-10 perform similar to SBS binder PG76-22. Based on the results, the low temperature PG grading of binders modified with the RaC was also improved, indicating a lower cracking potential at low temperatures.

Toughness and tenacity of asphalt binders. The toughness and tenacity of the binders were tested at room temperature (21° C.). For sample preparation, the binder was heated until soft and poured into a tin can where the tension head was inserted. The sample was left to cool down to room temperature before testing. The typical pull-out rate according to the ASTM is 508 mm/min. However, to better understand the elasticity of the materials, a low rate of 0.5 mm/sec was used to establish the toughness and tenacity of the materials. Toughness is defined as the total area under the load vs displacement curve, also defined as the work needed to separate the tension head from the material. Tenacity is defined as the stretch after the initial peak has been reached within the material. Having higher toughness and tenacity indicates a stronger and more flexible binder. The results show a significant improvement in both parameters for the modified asphalt binder. For the 20% RaC sample, the tenacity is significantly improved yielding better elasticity of the material without compromising the strength. Table 5 presents the results of this test for all the binders.

TABLE 5
Toughness and Tenacity of Binders

| Binder Type | Tenacity (N/mm) | Toughness (N/mm) |
|---|---|---|
| PG70-10 (Control) | 1,490 | 2,710 |
| PG76-22 (SBS) | 3,215 | 4,426 |
| PG70-10 + 20% RaC WM | 7,872 | 3,940 |
| PG70-10 + 20% aRaC CM | 6,033 | 5,365 |

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A recycled-aerogel composite comprising:
a multiplicity of swelled crumb rubber particles, wherein each swelled crumb rubber particle comprises:
a crumb rubber particle defining pores; and
oil distributed throughout the pores; and
a filler comprising:
a multiplicity of fibers;
aerogel material; or
both.

2. (canceled)

3. The recycled-aerogel composite of claim 1, wherein each fiber in the multiplicity of fibers has a diameter in a range of about 5 microns to about 20 microns and a length in a range of about 1 centimeter to about 10 centimeters.

4. (canceled)

5. The recycled-aerogel composite of claim 1, wherein the aerogel material comprises silica aerogel crosslinked with polystyrene.

6. (canceled)

7. (canceled)

8. The recycled-aerogel composite of claim 1, wherein the aerogel material comprises aerogel particles having a diameter in a range of about 50 microns to about 100 microns.

9. The recycled-aerogel composite of claim 1, wherein the aerogel material comprises aerogel particles having a diameter in a range between about 500 microns and about 3 millimeters.

10. The recycled-aerogel composite of claim 1, wherein the aerogel material comprises aerogel fibers having a diameter in a range between about 5 microns and about 40 microns and a length between about 1 centimeter and about 10 centimeters.

11. The recycled-aerogel composite of claim 1, wherein the aerogel material comprises aerogel strips having a width in a range between about 5 microns and about 40 microns and a length between about 1 centimeter and about 10 centimeters.

12. (canceled)

13. The recycled-aerogel composite of claim 1, comprising about 1 wt % to about 10 wt % of an encapsulator.

14. The recycled-aerogel composite of claim 13, wherein the encapsulator comprises one or more asphalt binders, polymers, bio-binders, heavy oil products, bio-derived compounds, bio-oils, or any combination thereof.

15. The recycled-aerogel composite of claim 14, wherein a weight ratio of the aerogel material to the asphalt binder is in a range of about 1:10 to about 3:4.

16. The recycled-aerogel composite of claim 13, wherein the encapsulator comprises one or more heavy oil products, synthetic polymers, organic polymers, bio-derived compounds, bio-oils, or any combination thereof.

17. The recycled-aerogel composite of claim 16, wherein the bio-derived compounds comprise lignin, polymers, tree resin, or a combination thereof.

18. The recycled-aerogel composite of claim 17, wherein the polymers comprise poly(ethylene glycol) (PEG), poly(propylene glycol) (PPG), poly(tetrahydrofuran) (PTHF), or a combination thereof.

19. (canceled)

20. (canceled)

21. (canceled)

22. The recycled-aerogel composite of claim 1, wherein each crumb rubber particle of the multiplicity of crumb rubber particles has an average diameter in a range of about 0.2 millimeters to about 2 millimeters.

23. (canceled)

24. (canceled)

25. (canceled)

26. The recycled-aerogel composite of claim 1, wherein the swelled crumb rubber particles comprise an oil to crumb rubber particle weight ratio between about 1:4 and about 1:3.

27. (canceled)

28. A modified asphalt binder comprising:
asphalt binder; and
the recycled-aerogel composite of claim 1.

29. (canceled)

30. (canceled)

31. An asphalt pavement comprising:
the modified asphalt binder of claim 28; and
aggregate.

32. (canceled)

33. (canceled)

34. (canceled)

35. A method of making modified asphalt binder, the method comprising:
combining an asphalt binder with the recycled-aerogel composite of claim 1 to yield the modified asphalt binder.

36. (canceled)

37. (canceled)

38. (canceled)

39. A method of making a recycled-aerogel composite, the method comprising:
contacting crumb rubber particles with oil to yield swelled crumb rubber particles;
combining the swelled crumb rubber particles with an encapsulator to yield a mixture; and
combining the mixture with aerogel material to yield the recycled-aerogel composite.

40. A method of making a recycled-aerogel composite, the method comprising:
contacting crumb rubber particles with oil to yield swelled crumb rubber particles;
combining the swelled crumb rubber particles and aerogel material to yield a mixture;
combining an encapsulator with the mixture, wherein the encapsulator at least partially encapsulates each of the swelled crumb rubber particles and the aerogel material.
